(19) United States
(12) Patent Application Publication
(10) Pub. No.: US 2022/0415347 A1
(43) Pub. Date: Dec. 29, 2022

(54) LOW FORCE ACTUATOR WITH A COUPLER PIECE AND CONSTRAINED LAYER CONSTRUCTION

(71) Applicant: Seagate Technology LLC, Freemont, CA (US)

(72) Inventors: Rohit Deokar, Eden Prairie, MN (US); Razman Zambri, Eden Prairie, MN (US)

(73) Assignee: Seagate Technology LLC, Fremont, CA (US)

(21) Appl. No.: 17/362,865

(22) Filed: Jun. 29, 2021

(51) Int. Cl. G11B 5/48

(52) U.S. Cl. CPC G11B 5/4833; G11B 5/4826

(57) ABSTRACT

A method for manufacturing a suspension assembly for a hard disk drive. The method includes applying a resist mask pattern onto a coupler piece, where the resist mask pattern defines an aperture in the coupler piece. The aperture has dimensions large enough to enable a plurality of actuators to fit within said aperture. The method includes etching the coupler piece into the shape of the resist mask and removing the resist mask after patterning.

### TECHNICAL FIELD

The disclosure relates to a suspension assembly for a hard disk drive.

### BACKGROUND

Hard disk drives (HDDs) utilize a slider to read and write data on magnetic storage media. Typically, the slider is mounted to a free end of a suspension assembly that in turn is cantilevered from the arm of a rotary actuator mounted on a stationary pivot shaft. In some examples, the suspension assembly has a base plate that attaches to the actuator arm and a load beam that extends from the base plate to the free end of the suspension assembly where a slider is mounted on a flexure, thus enabling the slider to actuate about a center of rotation. Position control of the slider relative to data tracks on the spinning magnetic disk medium is limited by the inertial excitation loads induced in the actuator arm as the head is actuated by the suspension assembly. Such torque and lateral loads can result in unwanted excitation of actuator arm sway and torsion modes which in turn can cause an unwanted lateral displacement of the slider.

### SUMMARY

The present disclosure describes a head suspension assembly (I-ISA) for a hard disk drive. The HSA includes a coupler piece connected to the base plate and the load beam of a head gimbal assembly (HGA). The coupler piece may be manufactured by an etching process or by a stamping process or by other methods of manufacture. Etching the coupler piece may allow for greater precision of coupler piece geometry than stamping the coupler piece. Including an etched coupler piece between the base plate and the load beam of the HGA may allow for better tuning and improvement of the frequency response of the HGA and HSA by potentially reducing the amount of excitation of sway and torsion modes in the HGA. Reducing the gain in the sway and torsion modes may improve the ability of the HGA to accurately position the slider, which may enable the slider to more accurately read and write data on the magnetic media.

In one example, a method of manufacturing a head suspension assembly for a hard disk drive includes applying a resist mask pattern onto a coupler piece, where the resist mask pattern defines an aperture in the coupler piece. The aperture has dimensions large enough to enable a plurality of actuators to fit within said aperture. The method includes etching the coupler piece into the shape of the resist mask and removing the resist mask after patterning.

These and other features and aspects of various examples may be understood in view of the following detailed discussion and accompanying drawings.

### BRIEF DESCRIPTION OF THE DRAWINGS

FIG. 1 is a perspective view of a hard disk drive, according to various aspects of the present disclosure.

FIG. 2 is a top view of an example head suspension assembly, according to various aspects of the present disclosure.

FIG. 3 is a perspective view of an example head gimbal assembly, according to various aspects of the present disclosure.

FIG. 4A is a top view of an example head gimbal assembly according to various aspects of the present disclosure. FIG. 4B is a side view of an example head gimbal assembly, according to various aspects of the present disclosure.

FIG. 5A is a top view of an example head gimbal assembly according to various aspects of the present disclosure. FIG. 5B is a side view of an example head gimbal assembly, according to various aspects of the present disclosure.

FIG. 6A is a top view of an example head gimbal assembly according to various aspects of the present disclosure. FIG. 6B is a side view of an example head gimbal assembly, according to various aspects of the present disclosure.

FIG. 7 is a flow diagram illustrating example operations for manufacture of an example head gimbal assembly according to various aspects of the present disclosure.

### DETAILED DESCRIPTION

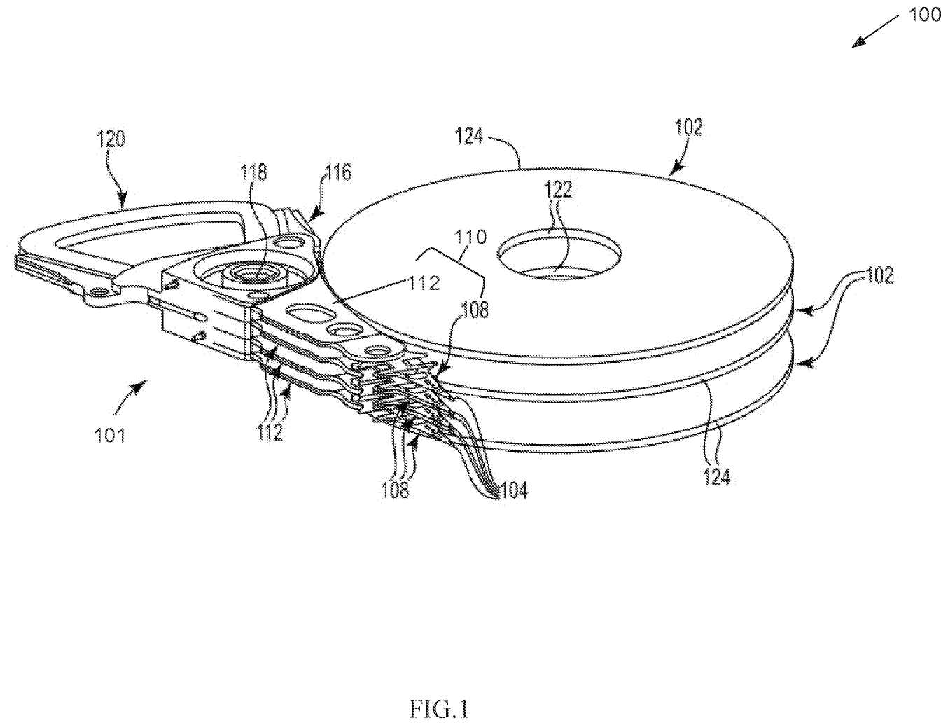

FIG. 1 is a perspective view of a hard disk drive, according to various aspects of the present disclosure. Hard disk drive 100 includes a head stack assembly (HSA) 101 and magnetic media 102. In one example, magnetic media 102 includes magnetic disks that each store information or data in a plurality of circular, concentric data tracks.

HSA 101 includes a voice coil drive actuator 120, an actuator mechanism 116, shaft 118, a plurality of rotatable drive actuator arms 112, and a plurality of head gimbal assemblies 108. Drive actuator arm 112 together with head gimbal assembly 108 forms head suspension assembly 110. Voice coil drive actuator 120 is controlled by servo control circuitry. Voice coil drive actuator 120 is configured to rotate actuator mechanism 116 about shaft 118 in either rotational direction. Drive actuator arms 112 are each coupled to a respective HGA of HGAs 108, such that rotating actuator mechanism 116 causes drive actuator arms 112 and HGAs 108 to move relative to magnetic media 102. Each HGA 108 includes a respective slider 104. Positioning HGAs 108, and thus sliders 104, over the surfaces of magnetic media 102, between inner diameters 122 and outer diameters 124 of magnetic media 102, enables sliders 104 to read data from and write data to magnetic media 102. In some examples, sliders 104 are themselves aerodynamically designed to fly on an air bearing that is created adjacent to each disk surface during disk rotation.

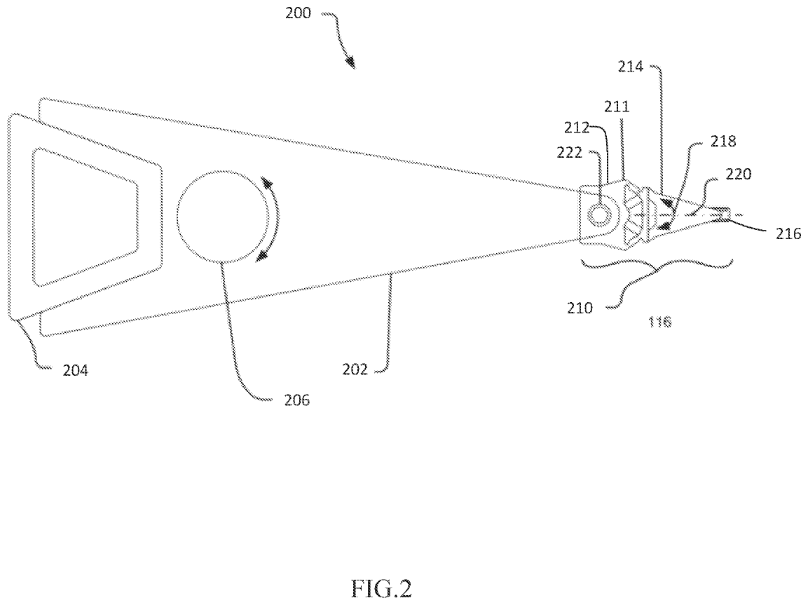

FIG. 2 is a top view of an example head suspension assembly, according to various aspects of the present disclosure. Head suspension assembly 200 includes head gimbal assembly 210 and drive actuator arm 202. Drive actuator arm 202 is coupled to voice coil drive actuator 204. Voice coil drive actuator 204 is used to actuate head suspension assembly 200. Drive actuator arm 202 is attached to shaft 118 of FIG. 1 through a pivot bearing located at a drive actuator pivot location 206, which allows drive actuator arm 202 to pivot about the drive actuator pivot location 206.

Head gimbal assembly 210 is mounted on drive actuator arm 202. Head gimbal assembly includes a load beam 214, a coupler piece 211 and a base plate 212.

Load beam 214 includes slider 216 which is attached to one end of load beam 214. Slider 216 is used to hold a read/write head that reads and/or writes data from storage media (e.g., magnetic media 102 of FIG. 1). In one example, a slider is an integrated device that includes a magnetic write element (sometimes referred to as a “write head”) and a magnetic read element (sometimes referred to as a “read head”). The write element may include an inductive yoke structure and the read element may include any of various species of magnetoresistive sensors.

In the example of FIG. 2, coupler piece 211 is mechanically coupled to load beam 214 and base plate 212. Base plate 212 attaches HGA 210 to drive actuator arm 202. In the example of FIG. 2, base plate 212 is swage-mounted to drive actuator arm 202 at attachment point 222. In one example, drive actuator arm 202 is adapted to swivel around the actuator pivot location 206 in both a clockwise and a counterclockwise direction. Similarly, the load beam 214 of head gimbal assembly 210 is also adapted to swivel in both clockwise and counterclockwise direction. In other words, load beam 214 swivels about a center of rotation located on a centerline 220 passing through the center of attachment point 222.

In another example, during actual operation of the head suspension assembly 200 for any given read/write operation, when the drive actuator arm 202 swivels in the clockwise direction, the load beam 214 swivels in the counter-clockwise direction. In an alternate implementation, both the drive actuator arm 202 and the load beam 214 swivel in the same direction for an operation, with the displacements of the drive actuator arm 202 and the load beam 214 being out of phase with each other. In yet another example, the swivel movements of the drive actuator arm 202 and the load beam 214 are both in opposite directions and out of phase with each other.

Actuation of the head suspension assembly induces translational inertial (or off-track) and rotational inertial loads on the head suspension assembly. In an out of phase implementation, the inertial loads induce torque about the longitudinal axis, the axis passing through the center of the actuator pivot location 206 and the center of the attachment point 222. In an in-phase implementation, the translational loads induce translational loads to the drive actuator arm 202.

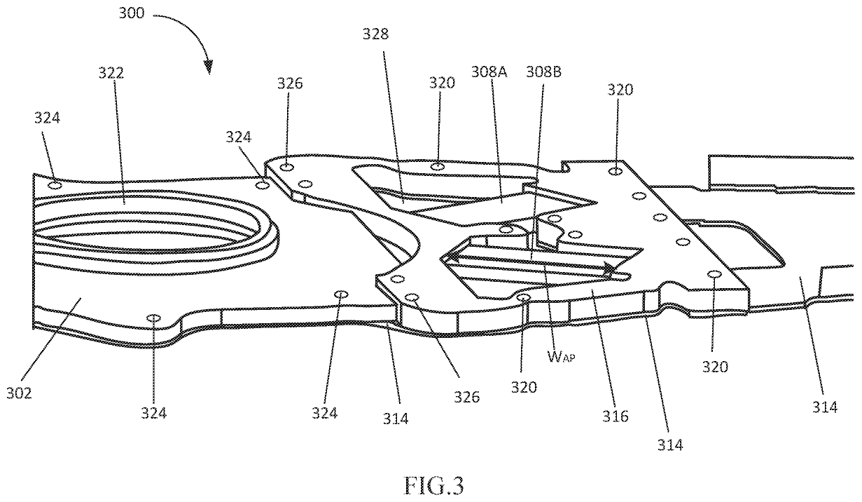

FIG. 3 is a perspective view of an example head gimbal assembly, according to various aspects of the present disclosure. Head gimbal assembly 300 is an example of head gimbal assembly 210 of FIG. 2. In the example of FIG. 3, head gimbal assembly 300 includes a base plate 302, a coupler piece 316, a load beam 314, aperture 328 and a plurality of actuators 308A and 308B (collectively, actuators 308).

Base plate 302 includes an attachment structure 322, such as a boss tower, configured to couple base plate 302 to drive actuator arm 202 of FIG. 2 (e.g., at attachment point 222). In one example, attachment structure 322 is integrally formed with base plate 302. Base plate 302 and attachment structure 322 may each be made of ferrite (e.g., stainless steel) or other suitable material (e.g., aluminum, engineered plastic, and the like).

Load beam 314 is mechanically coupled to base plate 302 and coupler piece 316. In one example, load beam 314 extends under base plate 302 and under coupler piece 316 to the tip of the head gimbal assembly. In some examples, a top surface of load beam 314 is coupled to a bottom surface of base plate 302 via welding (e.g., laser welding) at weld points 324. In the example of FIG. 3, a top surface of load beam 314 is also coupled to a bottom surface of coupler piece 316 via welding at weld points 320. Load beam 314 may terminate at slider 216. Load beam 314 may be made of ferrite (e.g., stainless steel) or other suitable material.

In some examples, head gimbal assembly 300 includes coupler piece 316. Coupler piece 316 may include a ferrite (e.g., stainless steel) or other suitable material. Coupler piece 316 includes aperture 328. Coupler piece 316 may be manufactured via a stamping process (which may also be referred to as a pressing process) and/or an etching process.

The etching process includes a first step of applying a resist mask pattern onto a top surface of coupler piece 316. The resist mask pattern may be formed by a variety of known techniques. In some examples, a patterned layer may be formed using photolithography. Photolithography uses light to transfer a pattern from a photomask to a light-sensitive photoresist. The resist mask pattern defines aperture 328. After formation of the pattern in the photoresist mask, coupler piece 316 may be exposed to an etching process. During the etching process, any area on the top surface of coupler piece which is not covered by photoresist is removed and aperture 328 is etched into coupler piece 316. Following the etching process, the remaining photoresist is removed from the top surface of coupler piece 316.

In some examples coupler piece 316 may be a stamped coupler piece whereby aperture 328 is etched by an etching process. In other examples, coupler piece 316 may be formed via an etching process only or coupler piece 316 may be formed via a stamping process only.

In the example of FIG. 3, coupler piece 316 extends from load beam 314 to base plate 302. In some examples, a bottom surface of coupler piece 316 is mechanically coupled to a top surface of load beam 314 via welding at weld points 320. In some examples, a portion of a coupler piece 316 is mechanically coupled to base plate 302 via welding at weld points 326.

As shown in the example of FIG. 3, head gimbal assembly 300 includes a pair of actuators 308A and 308B (collectively, actuators 308) located within aperture 328. Aperture 328 is defined by width W_{AP} and is configured to store a plurality of actuators 308, that is, the width W_{AP} of aperture 328 is substantially the same as the length of actuators 308. In some examples, the width W_{AP} is between approximately 1200 microns and approximately 1400 microns. In one example, the width W_{AP} does not exceed 1400 microns.

While voice coil drive actuator 120 of FIG. 1 rotates actuator mechanism 116 to provide relatively coarse positioning of sliders 104, actuators 308 provide HGA 108 with relatively fine or precision positioning of slider 104 at the surface of magnetic media 102. In one example, actuators 308 are piezoelectric milliactuators. Piezoelectric milliactuators convert an electrical signal into controlled physical displacements. In another example, actuators 308 include lead zirconate titanate (PZT). In some examples, HGA 108 may include a plurality of pairs of milliactuators and/or a plurality of pairs of microactuators which may be positioned at various locations on HGA 108.

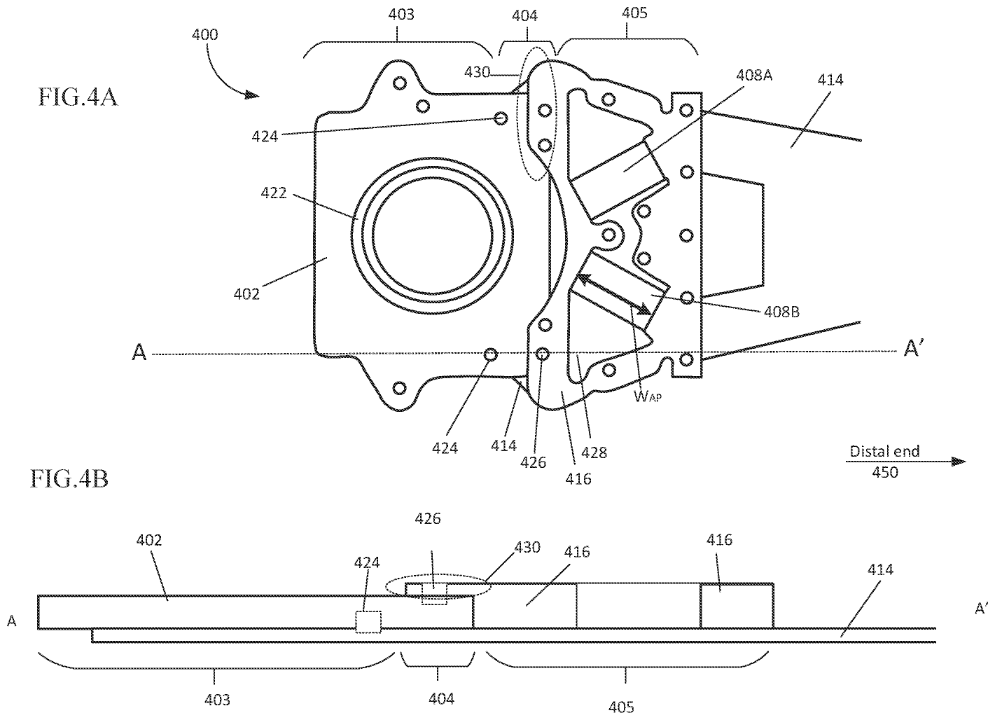

FIG. 4A is a top view of an example head gimbal assembly according to various aspects of the present disclosure. FIG. 4B is a side view of an example head gimbal assembly, according to various aspects of the present disclosure.

Head gimbal assembly 400 is an example of head gimbal assembly 300 of FIG. 3. In the example of FIG. 4A, head gimbal assembly 400 includes base plate 402, attachment structure 422, load beam 414, coupler piece 416, weld points 424 and 426, and actuators 408A and 408B (collectively, actuators 408).

In one example, base plate 402 is swage-mounted to a drive actuator arm using attachment structure 422. Attachment structure 422 is connected to attachment point 222 on drive actuator arm 202. In some examples, base plate 402 includes region 403 and region 404. Region 403 and region 404 each include a top surface and a bottom surface. A bottom surface of region 403 is mechanically coupled to a top surface of load beam 414 (e.g., via weld points 424).

In some examples, coupler piece 416 includes overhang region 430 and actuation region 405. A bottom surface of actuation region 405 is coupled to a top surface of load beam 414. Actuation region 405 may be thicker than overhang region 430. In the example of FIG. 4A, actuation region 405 includes aperture 428 which is configured to store a plurality of actuators (e.g., actuators 408).

Coupler piece 416 extends from the region 404 of base plate 402 on top of load beam 414 toward the distal end 450 of head gimbal assembly 400. In the example of FIGS. 4A and 4B, the thickness of coupler piece 416 may be thicker than the thickness of base plate 402. Making coupler piece 416 thicker than base plate 402 may also enhance the torsional stiffness of head gimbal assembly 400.

In the example of FIGS. 4A and 4B, coupler piece 416 is mechanically coupled to base plate 402. In the examples of FIG. 4A and FIG. 4B, a top surface of region 404 is coupled to a bottom surface of overhang region 430 (e.g., via weld point 426). Coupler piece 416 is mechanically coupled to load beam 414. For example, the bottom surface of actuation region 405 is coupled to the top surface of load beam 414.

Load beam 414 is mechanically coupled to base plate 402 and coupler piece 416. In some examples, load beam 414 may share the same footprint as coupler piece 416 in actuation region 405. That is, load beam 414 may include an aperture that overlaps aperture 428 of coupler piece 416. In some examples, the apertures overlap such that, when viewed from above as shown in FIG. 4A, load beam 414 is not visible. Utilizing a shared footprint for load beam 414 and coupler piece 416 in actuation region 405 may improve the torsional stiffness of head gimbal assembly 400.

Base plate 402 and/or coupler piece 416 may be manufactured via a stamping process. In some examples, stamping base plate 402 and/or coupler piece 416 may limit the manufacture of small feature sizes and may also lead to deformation of parts manufactured using this process.

In some examples, coupler piece 416 may be manufactured separately to base plate 402. In one example, coupler piece 416 may be manufactured using an etching process. Using an etching process in the manufacture of coupler piece 416 may allow for finer tuning of features (e.g., aperture width W_{AP}) in coupler piece 416.

In some examples, coupler piece 416 is configured such that the center of mass of the moving components of the assembly during actuation may be located at approximately the same location as the center of rotation of load beam 414. Moving the center of mass of the moving components of the assembly during actuation closer to the center of rotation of load beam 414 may improve the frequency response of the drive actuator arm sway and drive actuator arm torsion modes in the head stack assembly (e.g., HSA 101 of FIG. 1) in the low frequency range (e.g., 0 to 10 kHz range). Further details of a head gimbal assembly where the center of mass of the moving components of the assembly during actuation is located at approximately the same location as the center of rotation of load beam 414 may be found in U.S. Pat. No. 9,286,923B2, filed on 14 Oct. 2011 and issued on 15 Mar. 2016, and entitled “Low translational load suspension assembly”, the contents of which are hereby incorporated by reference in its entirety.

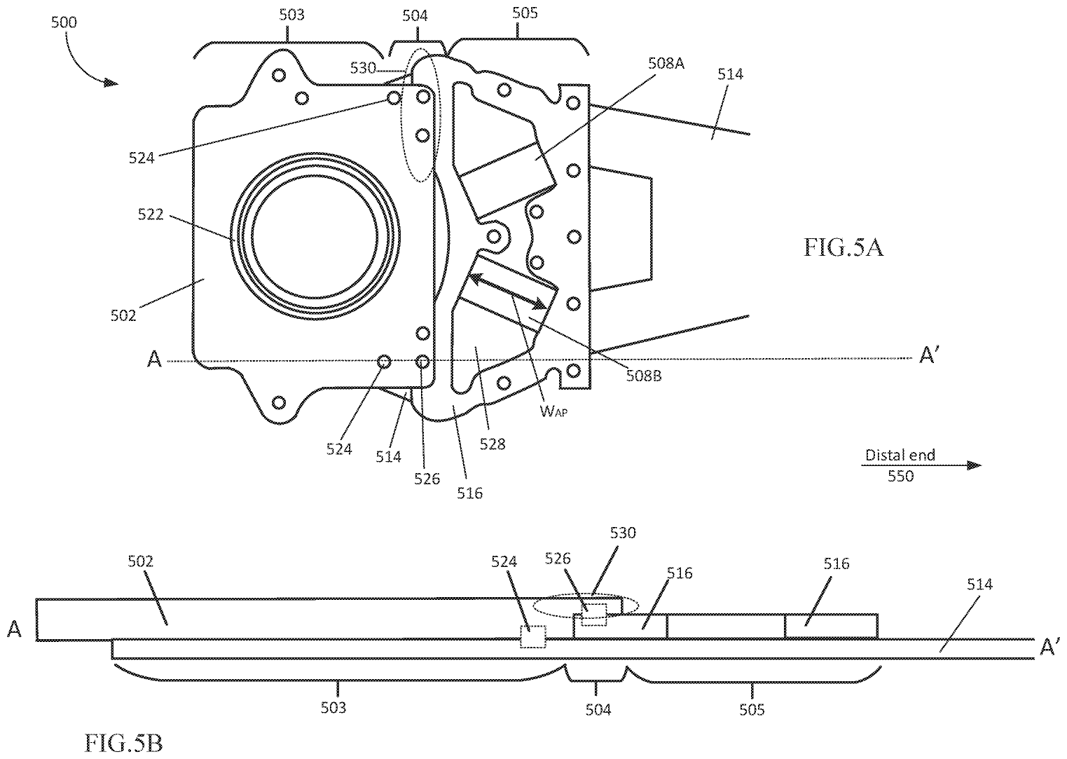

FIG. 5A is a top view of an example head gimbal assembly according to various aspects of the present disclosure. FIG. 5B is a side view of an example head gimbal assembly, according to various aspects of the present disclosure.

Head gimbal assembly 500 is an example of head gimbal assembly 300 of FIG. 3. In the example of FIG. 5A, head gimbal assembly 500 includes base plate 502, attachment structure 522, load beam 514, coupler piece 516, weld points 524 and 526, and actuators 508A and 508B (collectively, actuators 508).

In one example, base plate 502 is swage-mounted to a drive actuator arm using attachment structure 522. Attachment structure 522 is connected to attachment point 222 on drive actuator arm 202. In some examples, base plate 502 includes region 503 and region 504. Region 503 and region 504 each include a top surface and a bottom surface. A bottom surface of region 503 is mechanically coupled to a top surface of load beam 514 (e.g., via weld points 524).

In some examples, base plate 502 includes overhang region 530 and coupler piece 516 includes actuation region 505. In the example of FIG. 5A, actuation region 505 includes aperture 528 which is configured to store a plurality of actuators (e.g., actuators 508). A bottom surface of actuation region 505 is coupled to a top surface of load beam 514. Actuation region 505 may be thicker than overhang region 530. In some examples actuation region 505 may be thinner than overhang region 530. In some examples, the combined thickness of coupler piece 516 and region 504 of base plate 502 may be thicker than region 503 of base plate 502 or of coupler piece 516.

Coupler piece 516 extends from region 504 of base plate 502 on top of load beam 514 toward the distal end 550 of head gimbal assembly 500. In the example of FIGS. 5A and 5B, the thickness of coupler piece 516 may be thinner than the thickness of base plate 502. Making coupler piece 516 thinner than base plate 502 may degrade the frequency response of the drive actuator arm sway and drive actuator arm torsion modes in the head stack assembly (e.g., HSA 101 of FIG. 1) in the low frequency range (e.g., 0 to 10 kHz range). There may also be a decrease in the torsional stiffness of head gimbal assembly 500.

In the example of FIGS. 5A and 5B, coupler piece 516 is mechanically coupled to base plate 502. In the examples of FIG. 5A and FIG. 5B, a bottom surface of region 504 is coupled to a top surface of coupler piece 516 (e.g., via weld point 526). Coupler piece 516 is mechanically coupled to load beam 514. For example, the bottom surface of region 505 of coupler piece 516 is coupled to the top surface of load beam 514.

Load beam 514 is mechanically coupled to base plate 502 and mechanically coupled to coupler piece 516. In some examples, load beam 514 may share the same footprint as coupler piece 516 in actuation region 505. In some examples the apertures overlap such that, when viewed from above as shown in FIG. 5A, load beam 514 is not visible. Utilizing a shared footprint for load beam 514 and coupler piece 516 in actuation region 505 may improve the torsional stiffness of head gimbal assembly 500.

Base plate 502, load beam 514 and/or coupler piece 516, may be manufactured via a stamping process. In some examples, stamping base plate 502, load beam 514 and/or coupler piece 516 may limit the manufacture of small feature sizes and may also lead to deformation of parts manufactured using this process. In some examples, coupler piece 516 may be manufactured separately to base plate 502. In one example, coupler piece 516 may be manufactured using an etching process. Using an etching process in the manufacture of coupler piece 516 may allow for finer tuning of features (e.g., aperture width W_{AP}) in coupler piece 516. In some examples, a thinner coupler piece is easier to etch than a thicker coupler piece.

In some examples, coupler piece 516 is configured such that center of mass of the moving components of the assembly during actuation may be located at approximately the same location as the center of rotation of load beam. Moving the center of mass of the moving components of the assembly during actuation closer to the center of rotation of load beam 514 may improve the frequency response of the drive actuator arm sway and drive actuator arm torsion modes in the head stack assembly (e.g., HSA 101 of FIG. 1) in the low frequency range (e.g., 0 to 10 kHz range).

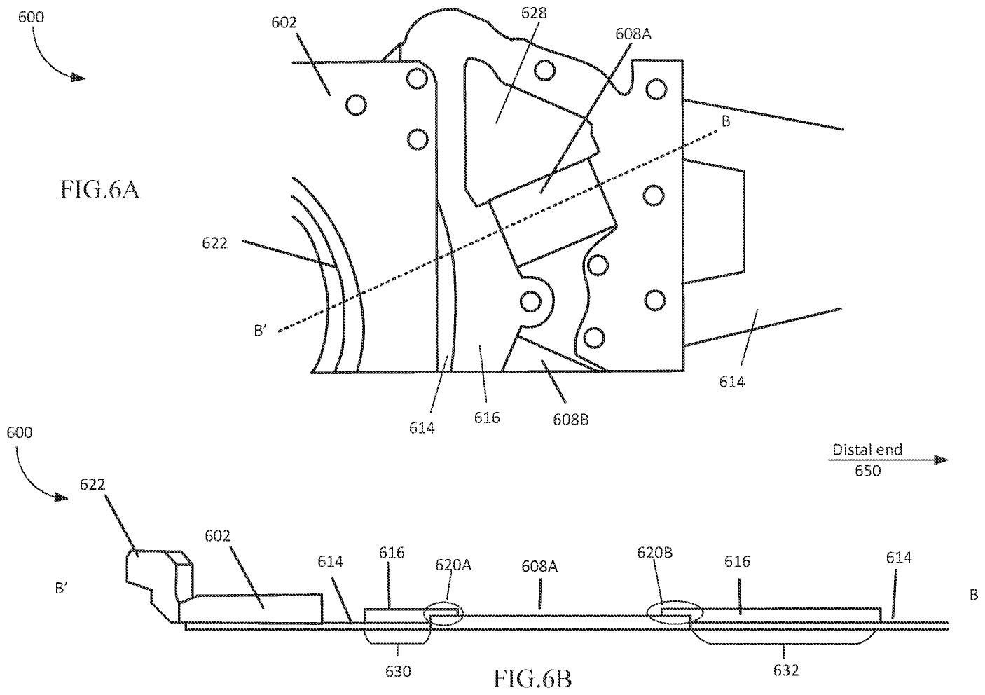

FIG. 6A is a top view of an example head gimbal assembly according to various aspects of the present disclosure. FIG. 6B is a side view of an example head gimbal assembly, according to various aspects of the present disclosure.

Head gimbal assembly 600 is an example of head gimbal assembly 500 of FIG. 5. In the example of FIG. 6A, head gimbal assembly 600 includes base plate 602, attachment structure 622, load beam 614, coupler piece 616, aperture 628 and actuators 608A and 608B (collectively, actuators 608).

In the example of FIG. 6A, the thickness of coupler piece 616 may be thinner than the thickness of base plate 602 as described in FIGS. 5A and 5B. This and other features of head gimbal assembly 600 are described in the detailed description of FIGS. 5A and 5B.

FIG. 6B is a side view of an example head gimbal assembly 600, according to various aspects of the present disclosure. In the example of FIG. 6B, head gimbal assembly 600 includes base plate 602, attachment structure 622, load beam 614, coupler piece 616, and actuator 608A. In some examples, coupler piece 616 includes overhang regions 620A and 620B (collectively, overhang regions 620). In overhang regions 620, a bottom surface of coupler piece 616 is coupled to a top surface of actuator 608A. Coupler piece 616 also includes region 630 and region 632 in which a bottom surface of coupler piece is coupled to a top surface of load beam 614.

In some examples, it may be possible to reduce the out-of-plane motion of HGA 600 by constraining actuators 608 via a constraining layer. In the example of FIG. 6B, the overhang regions 620 of coupler piece 616 may act as a constraining layer. With the overhang regions 620 of coupler piece 616 acting as a constraining layer, during actuation of actuators 608, bending of the actuators is constrained in a direction which produces a displacement field with low out-of-plane bending of HGA 600. Low out-of-plane bending of HGA 600 may result in lower off-track motion of the drive actuator arm sway and drive actuator arm torsion modes in the head stack assembly (e.g., HSA 101 of FIG. 1) in the low frequency range (e.g., 0 to 10 kHz range).

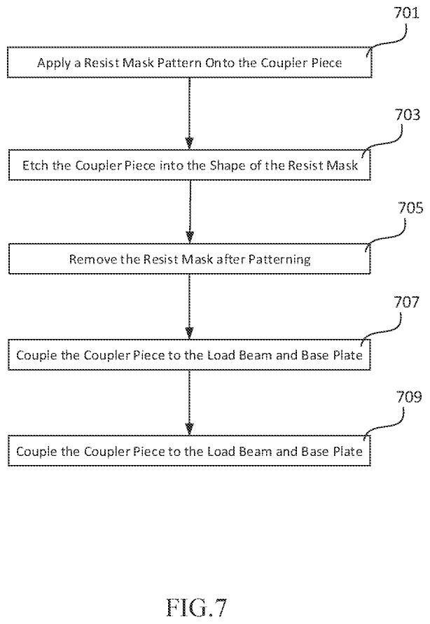

FIG. 7 is a flow diagram illustrating example operations for manufacture of an example head gimbal assembly according to various aspects of the present disclosure. FIG. 7 is described within the context of HGA 300 of FIG. 3. However, the method of FIG. 3 may apply to other HGAs, such as HGAs 400, 500, and 600 of FIGS. 4, 5, and 6, respectively.

In the example of FIG. 7, a resist mask pattern is applied to a coupler piece, such as coupler piece 316 of FIG. 3 (701). In some embodiments, the resist mask pattern may define an aperture that is configured to hold a plurality of actuators (e.g., actuators 308 of FIG. 3).

A resist mask pattern may be formed by a variety of known techniques. In some embodiments, a resist mask pattern may be formed using photolithography. Photolithography uses light to transfer a pattern from a photo-mask to light-sensitive photoresist. The resist mask pattern is provided to protect the masked portion of the coupler piece from the removal process that occurs during etching of the coupler piece.

Following the application of the resist mask pattern onto coupler piece, the coupler piece is etched into the shape of the resist mask (703). During the etching process, any portion of the coupler piece not covered by the resist mask will be etched by the etching process. Examples of etching processes include reactive ion etching (RIE) or plasma etching.

Following the etching process, any remaining resist mask pattern is removed (705).

In the example of FIG. 7, coupler piece such as coupler piece 316 of FIG. 3 is coupled to load beam, such as load beam 314 of FIG. 3 and base plate, such as base plate 302 of FIG. 3 (707). In some examples, coupler piece 316 is mechanically coupled to load beam 314, e.g., via welding at weld points 320. In some examples, a portion of a coupler piece 316 is mechanically coupled to base plate 302, e.g., via welding at weld points 326.

Following the coupling of coupler piece to the load beam and base plate, actuators, such as actuators 308 of FIG. 3 are placed within the aperture of the coupler piece (709).

Various examples have been presented for the purposes of illustration and description. These and other examples are within the scope of the following claims.

1. A method of manufacturing a suspension assembly for a hard disk drive, the method comprising:
stamping a baseplate;
stamping a load beam;
forming a coupler piece by;
applying a resist mask pattern onto a coupler piece, the resist mask pattern defining an aperture in the coupler piece, wherein the aperture is configured to hold a plurality of actuators;
etching the coupler piece into the shape of the resist mask; and
removing the resist mask pattern after etching;
mechanically coupling the coupler piece to the load beam and to the base plate; and
mechanically coupling the load beam directly to the base plate.

2. The method of claim 1, wherein a width of the aperture does not exceed 1400 microns.

3. The method of claim 1, further comprising mechanically coupling the coupler piece to a load beam.

4. The method of claim 3, further comprising mechanically coupling the coupler piece and the load beam to a base plate.

5. The method of claim 4, wherein the coupler piece and the load beam are welded to the base plate.

6. (canceled)

7. (canceled)

8. The method of claim 1, further comprising the manufacture of a suspension assembly, wherein the manufacture includes the coupler piece and a base plate.

9. A head assembly for a hard disk drive, the head gimbal assembly comprising;
a base plate comprising a first region and a second region;
a load beam, a portion of a top surface of the load beam coupled to a bottom surface of the first region of the base plate; and
a coupler piece coupled to the load beam and the base plate, wherein a first surface of the coupler piece is coupled to the second region of the base plate and a second surface of the coupler piece is coupled to the top surface of the load beam,
wherein a combined thickness of the coupler piece and the second region of the base plate is greater than a thickness of the first region of the base plate or a thickness of the coupler piece.

10. The head gimbal assembly of claim 9, wherein the coupler piece is thicker than the base plate.

11. The head gimbal assembly of claim 9, wherein the coupler piece is thinner than the base plate.

12. The head gimbal assembly of claim 9, wherein the base plate is a stamped base plate.

13. The head gimbal assembly of claim 9, wherein the load beam is a stamped load beam.

14. The head gimbal assembly of claim 9, wherein the coupler piece, the load beam and the base plate comprise ferrite.

15. The head gimbal assembly of claim 9, wherein the coupler piece includes an aperture.

16. The head gimbal assembly of claim 15, wherein a width of the aperture does not exceed 1400 um.

17. The method of claim 1, the method comprising:
forming at least one overhang region on the coupler piece; and
constraining the plurality of actuators with the at least one overhang region of the coupler piece.

18. A method of manufacturing a suspension assembly for a hard disk drive, the method comprising:
applying a resist mask pattern onto a coupler piece, the resist mask pattern defining an aperture in the coupler piece, wherein the aperture is configured to hold a plurality of actuators;
etching the coupler piece into the shape of the resist mask; and
removing the resist mask pattern after etching;
forming at least one overhang region on the coupler piece;
constraining the plurality of actuators with the at least one overhang region of the coupler piece.

19. The method of claim 18, wherein a width of the aperture does not exceed 1400 microns.

20. The method of claim 18, further comprising mechanically coupling the coupler piece to a load beam.

21. The method of claim 20, further comprising mechanically coupling the coupler piece and the load beam to a base plate.

22. The method of claim 21, wherein the coupler piece and the load beam are welded to the base plate.
